(19) United States
(12) Patent Application Publication
(10) Pub. No.: US 2010/0002434 A1
(43) Pub. Date: Jan. 7, 2010

(54) ILLUMINATION DEVICE

(75) Inventor: SHAN-FU HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/485,933

(22) Filed: Jun. 17, 2009

(30) Foreign Application Priority Data
Jul. 4, 2008 (CN) 200810302550.3

(51) Int. Cl. F21V 1/00; F21S 8/00

(52) U.S. Cl. 362/235; 362/268

(57) ABSTRACT

An illumination device includes an optical lens module, a light emitting module, and a reflective layer. The optical lens module includes a plurality of stepped optical lenses. Each of the stepped optical lenses includes an upper surface, a lower surface opposite to the upper surface, and a side surface between the upper surface and the lower surface. The light emitting module includes a substrate and a plurality of light sources mounted on the substrate. Each of the light sources faces the side surface of each of the stepped optical lenses. Light emitted from the light sources travels to the side surface and is refracted from the side surface. The reflective layer is coupled to the substrate.

### BACKGROUND

1. Technical Field

The present disclosure relates to an illumination device including an optical lens module and a light emitting module.

2. Description of Related Art

Known implementations of light emitting modules in an illumination device make use of a plurality of individual lamps to generate light. The large number of lamps, however, increases price and power consumption of the module. Considerable heat is also generated, which, if not adequately addressed at additional expense, impacts lamp reliability. Furthermore, since the light-emitting diodes (LEDs) are generally arranged on a printed circuit board having a planar surface, light-emitting range of the LED is usually between 90° and 120° and irradiation distance of the LED is short, making it unsuitable for environments requiring increased illumination.

Therefore, an illumination device is desired to overcome the limitations described.

### BRIEF DESCRIPTION OF THE DRAWINGS

Many aspects of an illumination device can be better understood with reference to the following drawings. The components in the drawings are not necessarily drawn to scale, the emphasis instead being placed upon clearly illustrating the principles of the present apparatus for assembling a machine tool. Moreover, in the drawings, like reference numerals designate corresponding parts throughout the several views.

FIG. 1 is a cross section of a first embodiment of an illumination device according to the disclosure.

FIG. 2 is a cross section of a second embodiment of an illumination device according to the disclosure.

### DETAILED DESCRIPTION

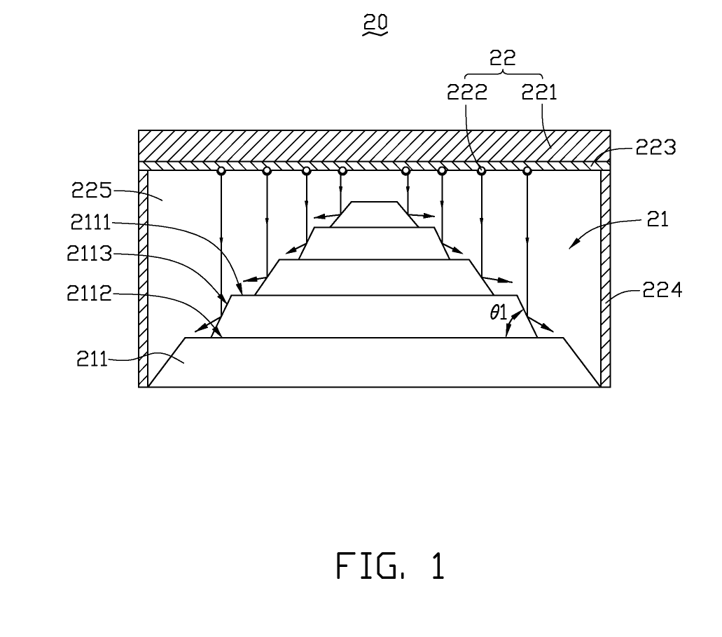

Referring to FIG. 1, a first embodiment of an illumination device 20 according to the disclosure includes an optical lens module 21 and a light emitting module 22.

The optical lens module 21 includes a plurality of stepped optical lenses 211 superposed one by one. Each of the optical lenses 211 includes an upper surface 2111, a lower surface 2112 opposite to the upper surface 2111, and a side surface 2113 between the upper surface 2111 and the lower surface 2112. The side surface 2113 is a reflective surface.

The light emitting module 22 is opposite to the optical lens module 21. The light emitting module 22 includes a substrate 221 and a plurality of light sources 222 mounted on the substrate 221. It will be appreciated that the plurality of light sources 222 can comprise a plurality of light-emitting diode (LED) chips, a plurality of LEDs, or a plurality of LED modules, all being equally applicable and remaining well within the scope of the disclosure. A reflective layer 223 is fixed on the substrate 221. Each of the light sources 222 faces the side surface 2113 of each of the optical lenses 211.

The illumination device 20 further includes a shell 224. The shell 224 is transparent plastic, translucent plastic, or glass. The shell 224 and the substrate 221 cooperatively define a receiving space 225 therebetween. The optical lens module 21 and the light sources 222 are received in the receiving space 225.

Light emitted from the light sources 222 travels to the side surface 2113 and is refracted from the side surface 2113 to the shell 224. Light emitted from the periphery of the light sources 222 travels to the upper surface 2111 and is refracted from the upper surface 2111. Some light is refracted from the upper surface 2111 to the shell 224, and some light refracted from the upper surface 2111 reaches the reflective layer 223, to be refracted from the reflection layer 223 to the optical lens module 21. The optical lenses 211 increase brightness of the light sources 222, such that irradiation distance of the illumination device 20 is increased, and rates of utilization are improved.

In the illustrated embodiment, the light sources 222 are collimated lights, and the side surface 2113 is a fully reflective face. An included angle θ1 between the side surface 2113 and the lower surface 2112 is an acute angle between 30° and 70°, as an example.

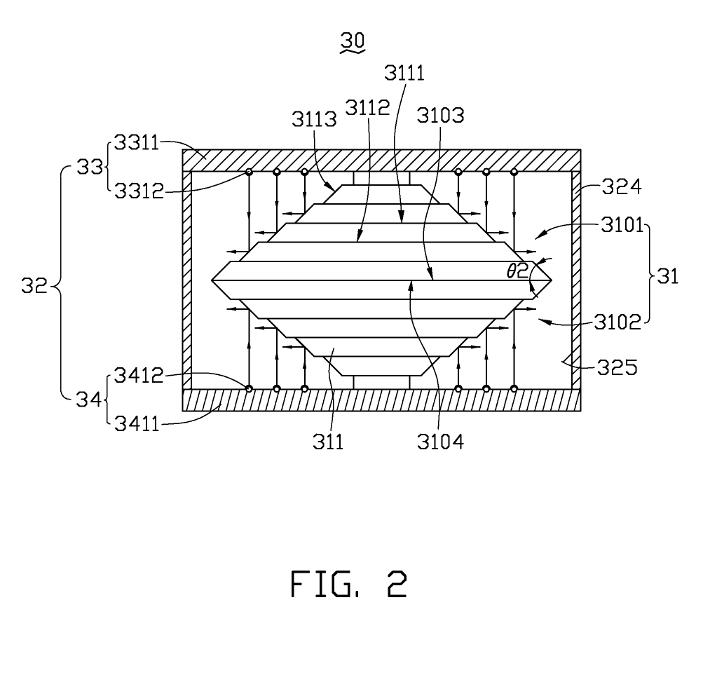

FIG. 2 is a cross section of a second embodiment of an illumination device 30 according to the disclosure, differing from illumination device 20 in that optical lens module 31 includes first optical lenses 3101 and second optical lenses 3 102. The first optical lenses 3101 and the second optical lenses 3102 are positioned oppositely to each other. A first bottom surface 3103 of the first optical lenses 3101 is connected to a second bottom surface 3104 of the second optical lenses 3102. A light emitting module 32 includes a first light emitting module 33 and a second light emitting module 34. The first light emitting module 33 and the second light emitting module 34 are positioned opposite to each other.

The first optical lenses 3101 and the second optical lenses 3102 include a plurality of stepped optical lenses 311 superposed one by one. Each of the stepped optical lenses 311 includes an upper surface 3111, a lower surface 3112 opposite to the upper surface 3111, and a side surface 3113 between the upper surface 3111 and the lower surface 3112. The side surface 3113 is a reflective surface.

The first light emitting module 33 is opposite to the first optical lenses 3101. The first light emitting module 33 includes a first substrate 3311 and a plurality of first light sources 3312 mounted on the first substrate 3311. It will be appreciated that first light sources 3312 can comprise a plurality of light-emitting diode (LED) chips, a plurality of LEDs, or a plurality of LED modules, all being equally applicable and remaining well within the scope of the disclosure. Each of the first light sources 3312 faces the side surface 3113 of each of the stepped optical lenses 311.

The second light emitting module 34 is opposite to the second optical lenses 3102. The second light emitting module 34 includes a second substrate 3411 and a plurality of second light sources 3412 mounted on the second substrate 3411. It will be appreciated that second light sources 3412 can comprise a plurality of light-emitting diode (LED) chips, a plurality of LEDs, or a plurality of LED modules, all being equally applicable and remaining well within the scope of the disclosure. Each of the second light sources 3412 faces the side surface 3113 of each of the stepped optical lenses 311.

The first substrate 3311 is opposite to the second substrate 3411. The illumination device 30 further includes a shell 324. The shell 324 is transparent plastic, translucent plastic, or glass. The shell 324, the first substrate 3311, and the second substrate 3411 cooperatively define a receiving space 325 therebetween. The optical lens module 31, the first light sources 3312, and the second light sources 3412 are received in the receiving space 325.

In the illustrated embodiment, the first light sources 3312 and the second light sources 3412 are collimated lights, and the side surface 3113 is a fully reflective face. An included angle 02 between the side surface 3113 and the lower surface 3112 is an acute angle. The included angle θ2 is 45°, as one example.

Light emitted from the first light sources 3312 and the second light sources 3412 travels to the side surface 3113, to be refracted from the side surface 3113 to the shell 324. The first optical lenses 3101 and the second optical lenses 3102 increase the brightness of the first light sources 3312 and the second light sources 3412. Thus, the irradiation distance of the illumination device 20 is increased.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An illumination device, comprising:
an optical lens module comprising a plurality of stepped optical lenses, wherein each of the stepped optical lenses comprises an upper surface, a lower surface opposite to the upper surface, and a side surface between the upper surface and the lower surface;
a light emitting module opposite to the optical lens module, comprising a substrate and a plurality of light sources mounted on the substrate, wherein each of the light sources faces the side surface of each of the stepped optical lenses; and
a reflective layer coupled to the substrate.

2. The illumination device of claim 1, further comprising a shell, wherein the shell and the substrate cooperatively define a receiving space therebetween, wherein the receiving space receives the optical lens module and the light sources.

3. The illumination device of claim 1, wherein the shell comprises transparent plastic, translucent plastic, or glass.

4. The illumination device of claim 1, wherein the stepped optical lenses superpose one by one.

5. The illumination device of claim 1, wherein the side surface is a reflective surface.

6. The illumination device of claim 1, wherein the side surface is a fully reflective face.

7. The illumination device of claim 1, wherein the light sources comprise a plurality of light-emitting diode (LED) chips, a plurality of LEDs, or a plurality of LED modules.

8. The illumination device of claim 1, wherein the light sources are collimated lights.

9. The illumination device of claim 1, wherein an included angle between the side surface and the lower surface is an acute angle.

10. The illumination device of claim 9, wherein the included angle ranges between 30° and 70°.

11. An illumination device, comprising:
an optical lens module comprising first optical lenses and second optical lenses, wherein the first optical lenses and the second optical lenses are positioned opposite to each other, wherein the first optical lenses and the second optical lenses comprise a plurality of stepped optical lenses, wherein each of the stepped optical lenses comprises an upper surface, a lower surface opposite to the upper surface, and a side surface between the upper surface and the lower surface; and
a light emitting module comprising a first light emitting module opposite to the first optical lenses and a second light emitting module opposite to the second optical lenses, wherein the first light emitting module and the second light emitting module are positioned opposite to each other, wherein the first light emitting module comprises a first substrate and a plurality of first light sources mounted on the substrate, wherein each of the first light sources faces the side surface of each of the stepped optical lenses, wherein the second light emitting module comprises a second substrate and a plurality of second light sources mounted on the substrate, wherein each of the second light sources faces the side surface of each of the stepped optical lenses.

12. The illumination device of claim 11, further comprising a shell, wherein the shell, the first substrate, and the second substrate cooperatively define a receiving space therebetween, wherein the receiving space receives the optical lens module, the first light sources, and the second light sources.

13. The illumination device of claim 11, wherein the shell comprises transparent plastic, translucent plastic, or glass.

14. The illumination device of claim 11, wherein the stepped optical lenses superpose one by one.

15. The illumination device of claim 11, wherein the side surface is a reflective surface.

16. The illumination device of claim 11, wherein the side surface is a fully reflective face.

17. The illumination device of claim 11, wherein the first light sources and the second light sources comprise a plurality of light-emitting diode (LED) chips, a plurality of LEDs, or a plurality of LED modules.

18. The illumination device of claim 11, wherein the first light sources and the second light sources are collimated lights.

19. The illumination device of claim 11, wherein an included angle between the side surface and the lower surface is an acute angle.

20. The illumination device of claim 19, wherein the included angle is 45°.
